(19) United States
(12) Patent Application Publication
(10) Pub. No.: US 2005/0190670 A1
(43) Pub. Date: Sep. 1, 2005

(54) Method and apparatus for reproducing information recorded on a super resolution information storage medium

(75) Inventors: Joo-ho Kim, Yongin-si (KR); In-oh Hwang, Seongnam-si (KR); Hyun-ki Kim, Hwaseong-si (KR); Du-seop Yoon, Seongnam-si (KR)

Correspondence Address: STEIN, MCEWEN & BUI, LLP, 1400 EYE STREET, NW, SUITE 300, WASHINGTON, DC, 20005, US

(73) Assignee: SAMSUNG ELECTRONICS CO., LTD., Suwon-si (KR)

(21) Appl. No.: 11/051,515

(22) Filed: Feb. 7, 2005

(30) Foreign Application Priority Data
Feb. 11, 2004 (KR) 2004-8938

(51) Int. Cl. G11B 5/09; G11B 7/00

(52) U.S. Cl. 369/47.5; 369/116

(57) ABSTRACT

A method of and apparatus for reproducing information recorded in a super resolution information storage medium (SRISM) using an appropriate actual reproduction power, which is actually appropriate for reproduction, by actively detecting a threshold region that varies according to the reflectivity of the SRISM are provided. The method of reproducing information from an SRISM includes: radiating a light beam onto the SRISM, while varying a reproduction power of the laser beam, receiving the light beam reflected by the SRISM, and detecting a change in the level of a reproduction signal from the received light beam; calculating, based the change in the level of the reproduction signal, a reference reproduction power at which the gradient of a graph of the levels of the reproduction signal with respect to the reproduction power changes; and setting the actual reproduction power based on the reference reproduction power. The apparatus for reproducing information from an SRISM includes: an optical pickup unit including a light source which radiates a light beam having a range of power onto the SRISM, and a photodetector which receives the light beam reflected from the SRISM and detects a reproduction signal from the received light beam; and a signal processing unit which detects a change in the level of the reproduction signal according to a change in the reproduction power of the light beam radiated onto the SRISM by the light source and sets the actual reproduction power of the light beam emitted from the light source based on a reference reproduction power at which the gradient of a graph of the levels of the reproduction signal with respect to the reproduction power changes.

### CROSS-REFERENCE TO RELATED APPLICATIONS

This application claims all benefits accruing under 35 USC§119 from Korean Patent Application No. 2004-8938, filed on Feb. 11, 2004, in the Korean Intellectual Property Office, the disclosure of which is incorporated herein in its entirety by reference.

### BACKGROUND OF THE INVENTION

1. Field of the Invention

The present invention relates to a method and apparatus for reproducing information recorded in a super resolution information storage medium (hereinafter, referred to as an “SRISM”), and more particularly, to a method and apparatus for reproducing information recorded in an SRISM using a reproduction power, which is actually appropriate for reproduction, by actively detecting a threshold region that varies according to a reflectivity of the SRISM.

2. Related Art

Along with the recent advancement of information technology, the demand for a higher recording density information storage medium in which information is recorded on or reproduced from using an optical pickup unit positioned such as not to contact the storage medium is increasing.

To satisfy this requirement, an SRISM having record marks smaller than or equal to a resolution limit of a laser beam has been intensively researched. The SRISM includes a mask layer that generates surface plasmons when exposed to the laser beam and can achieve high-density recording using the surface plasmons generated in the mask layer.

For example, when an SRISM has a mask layer composed of platinum (Pt) and oxygen (O₂), or platinum oxide (PtOₓ), the PtOₓ of the mask layer decomposes into Pt and O₂ as the mask layer is irradiated by a laser beam. Near-field reproduction can be achieved with the SRISM using surface plasmons generated from the Pt. Thus, signals can be reproduced from record marks that are smaller than the resolution limit of the laser beam focused on the SRISM by an objective lens.

To ensure information reproduction from the SRISM, a carrier-to-noise ratio (CNR) of about 30 dB or greater is desired. A CNR sensitively varies according to a reproduction power of a laser diode used for generating a laser beam for information reproduction. Accordingly, a reproduction power greater than a predetermined level is desired.

FIG. 1 is a graph of a CNR versus a reproduction power in a conventional SRISM. The results, as shown in FIG. 1, are obtained from 75-nm-length record marks recorded at a recording power of 12.0 mW, a bias power of 1.1 mW and a duty cycle of 25%, while rotating the SRISM at a linear velocity of 5 m/s.

Referring to FIG. 1, when the reproduction power is changed from 1.3 mW to 1.4 mW, the CNR drastically increases to about 30 dB. The region in which the CNR drastically changes is referred to as a “threshold region” and is denoted by A.

However, the threshold region is not limited only to the region between 1.3 mW and 1.4 mW, as shown in FIG. 1, and may vary according to different manufacturers of SRISMs.

Information recorded on the SRISM requires a CNR of about 30 dB or greater. Thus, a reproduction power greater than the reproduction power in the threshold region is required to reproduce information from the SRISM.

However, when increasing the reproduction power above 2.0 mW in the graph of FIG. 1, problems such as a decrease in the CNR and damage of recording marks by reproduction signals occur. Therefore, it is undesirable to set the reproduction power of an information reproduction apparatus to be higher than the power level in the threshold region in order to avoid the problems as described above.

### SUMMARY OF THE INVENTION

The present invention advantageously provides a method and apparatus for reproducing information recorded on a super resolution information storage medium (hereinafter, referred to as an “SRISM”), in which a threshold region varying according to a reflectivity of the SRISM is detected based on the relationship between a reproduction power and reproduction signals to determine an appropriate actual reproduction power level, and a signal is reproduced at the actual reproduction power level.

According to an aspect of the present invention, a method of reproducing information from an SRISM including record marks smaller than a resolution limit of a laser beam comprises: radiating a laser beam onto the SRISM, while varying a reproduction power of the laser beam, receiving the laser beam reflected from the SRISM, and detecting a change in the level of a reproduction signal from the received laser beam; calculating, based on the change in the level of the reproduction signal, a reference reproduction power at which the gradient of a graph of the levels of the reproduction signal with respect to the reproduction power changes; and setting the actual reproduction power of the laser beam based on the reference reproduction power.

According to another aspect of the present invention, a method of reproducing information from an SRISM including record marks smaller than a resolution limit of a laser beam comprises: recording a reference signal for calculating a reference reproduction power by radiating a laser beam having a predetermined recording power onto a predetermined area of the SRISM; radiating a laser beam onto the SRISM, while varying a reproduction power of the laser beam, receiving the laser beam reflected from the SRISM, and detecting a change in the level of a reproduction signal from the received laser beam; calculating, based on the change in the level of the reproduction signal, a reference reproduction power at which the gradient of a graph of the levels of the reproduction signal with respect to the reproduction power changes; and setting the actual reproduction power of the laser beam based on the reference reproduction power.

According to another aspect of the present invention, an apparatus for reproducing information from an SRISM including record marks smaller than a resolution limit of a laser beam is provided. Such an apparatus comprises: an optical pickup unit including a light source which radiates a laser beam having a range of power onto the SRISM, and a photo-detector which receives the laser beam reflected from the SRISM and which detects a reproduction signal from the received laser beam; and a signal processing unit which detects a change in the level of the reproduction signal according to a change in the reproduction power of the laser beam radiated onto the SRISM by the light source and which sets the actual reproduction power of the laser beam emitted from the light source based on a reference reproduction power at which the gradient of a graph of the levels of the reproduction signal with respect to the reproduction power changes.

The signal processing unit may include: a power controller which controls the light source such that the laser beam having a range of power can be radiated onto the SRISM; a calculating portion which calculates the reference reproduction power at which the gradient of the graph of the levels of the reproduction signal with respect to the reproduction power changes; and a setting portion which sets the actual reproduction power based on the reference reproduction power.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the invention are limited only by the terms of the appended claims. The following represents brief descriptions of the drawings, wherein:

FIG. 1 is a graph of a CNR versus a reproduction power in a conventional super resolution information storage medium (SRISM) including record marks of 75 nm;

FIG. 2 is a sectional view of an SRISM according to an embodiment of the present invention;

FIG. 3 is a graph of a reproduction signal versus a reproduction power in the SRISM shown in FIG. 2;

FIG. 4 is a schematic diagram illustrating an information reproducing apparatus according to an embodiment of the present invention;

FIG. 5 is a flowchart illustrating an information reproducing method according to an embodiment of the present invention; and

FIG. 6 is a flowchart illustrating an information reproducing method according to another embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

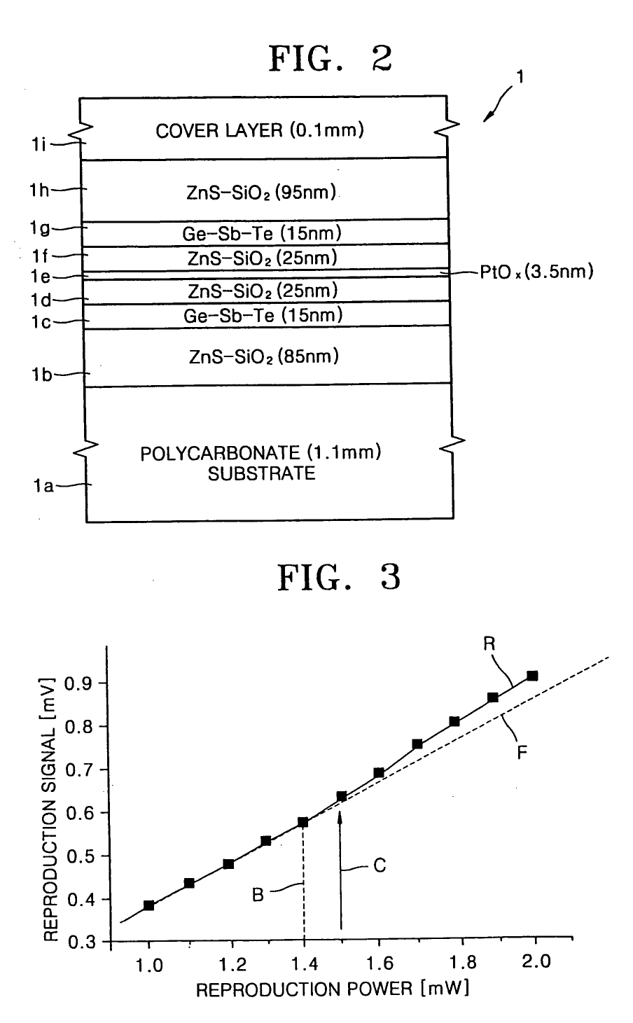

Before describing various embodiments of an information reproducing method and apparatus according to the present invention, the relationship between reproduction signal variations with respect to a reproduction power will be described with reference to an SRISM having a structure shown in FIG. 2.

Referring to FIG. 2, the SRISM 1 includes a carbonate substrate and a series of dielectric layers and auxiliary recording layers formed on the carbonate substrate and protected by a cover layer. As shown in FIG. 2, the SRISM 1 is formed by sequentially stacking a dielectric layer 1b made of ZnS—SiO₂ with a thickness of approximately 85 nm, an auxiliary recording layer 1c made of Ge—Sb—Te with a thickness of approximately 15 nm, a dielectric layer 1d made of ZnS—SiO₂ with a thickness of approximately 25 nm, a recording layer 1e made of a platinum oxide (PtOₓ) with a thickness of approximately 3.5 nm, a dielectric layer 1f made of ZnS—SiO₂ with a thickness of approximately 25 nm, an auxiliary recording layer 1g made of Ge—Sb—Te with a thickness of approximately 15 nm, and a dielectric layer 1h made of ZnS—SiO₂ with a thickness of approximately 95 nm on a carbonate substrate 1a with a thickness of approximately 1.1 mm using sputtering. A cover layer 1i with a thickness of approximately 0.1 mm is formed on the uppermost dielectric layer 1h. The structure of the SRISM 1, as shown in FIG. 3, advantageously allows information reproduction using a super resolution phenomenon and can be used to reproduce signals from record marks that are smaller than a resolution limit of a light beam (i.e., laser beam). For example, using an optical pickup apparatus having a resolution of 119 nm, record marks having a length of 75 nm, which is smaller than the resolution limit of the optical pickup apparatus, can be reproduced with a high degree of reliability and stability.

The relationship between the reproduction power used to reproduce information from the record marks of the SRISM that are smaller than the resolution limit of a reproducing light beam (laser beam) and the level of a signal reproduced therefrom is illustrated in FIG. 3.

FIG. 3 is a graph of reproduction signal variations with respect to a reproduction power in the SRISM shown in FIG. 2. A reproduction signal is measured in units of approximately 0.1 mW, while varying the reproduction power for a reference signal in a range from approximately 1.0 mW to approximately 2.0 mW. Here, the reference signal refers to a signal read from an approximately 75-nm-length mark at a recording power of approximately 12.0 mW, while rotating the SRISM at a linear velocity of approximately 5 m/s.

Referring to FIG. 3, line R, which connects the reproduction signal levels at different reproduction power levels, is linear and has a constant gradient between approximately 1.0 mW and approximately 1.4 mW. A line extended between the reproduction power levels from approximately 1.0 mW to approximately 1.4 mW at a constant gradient matches line F.

However, at a reproduction power of approximately 1.4 mW or greater, line R is no longer linear and does not match with line F.

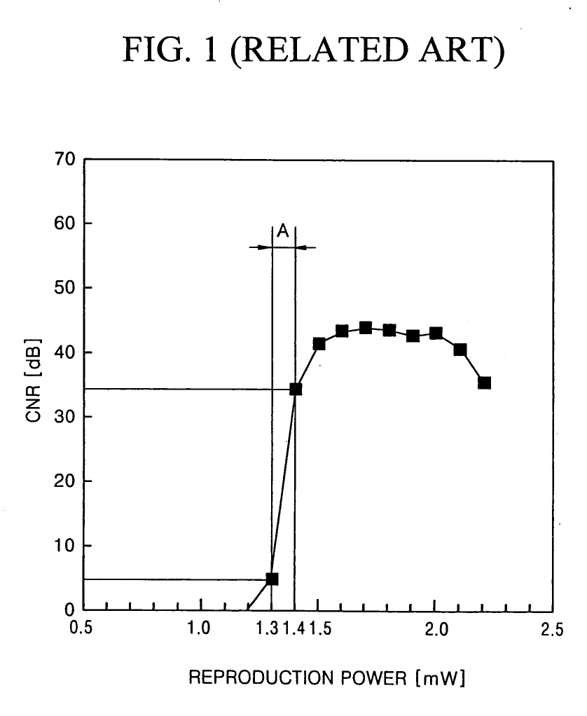

Comparing the graph shown in FIG. 3 with the graph of a CNR versus a reproduction power shown in FIG. 1, a maximum reproduction power for which the gradient of line R does not change is approximately 1.4 mW corresponding to the upper boundary of the threshold region (A) shown in FIG. 1. When the maximum reproduction power is defined as a reference reproduction power (B), it is possible to reproduce information from record marks having a size smaller than or equal to the resolution limit of reproducing light beam (i.e., laser beam) using a reproduction power greater than the reference reproduction power B.

In an SRISM having a different structure from the structure shown in FIG. 2, the level of a reproduction power at which the gradient of line R changes corresponds to the upper boundary of the threshold region A. However, the reference reproduction power B can vary according to, for example, reflectivity. In this case, the reference reproduction power B is determined based on the level of a reproduction power at which the gradient of line R changes.

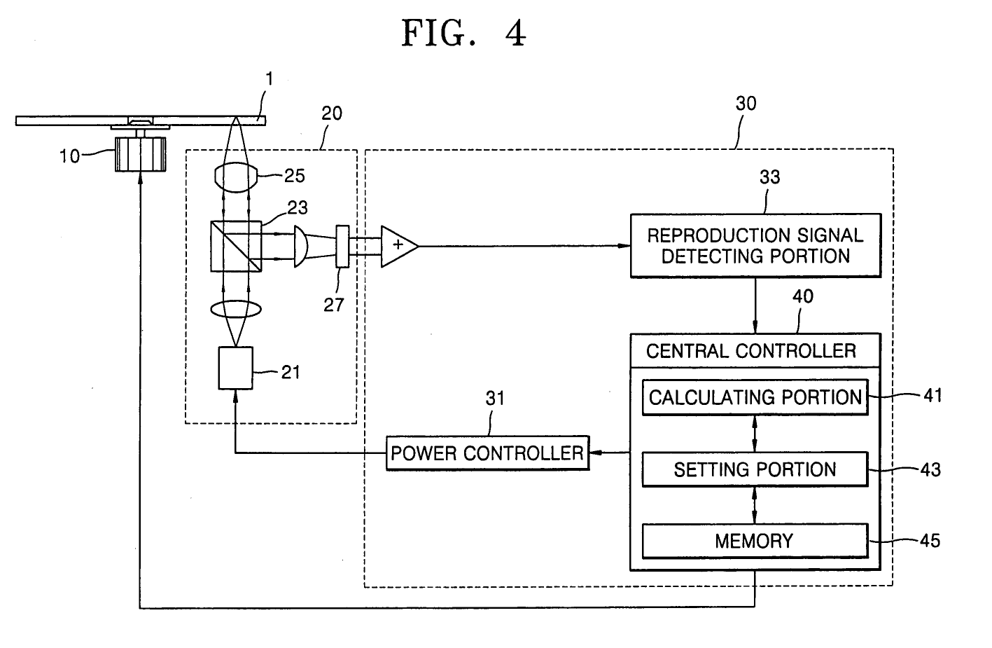

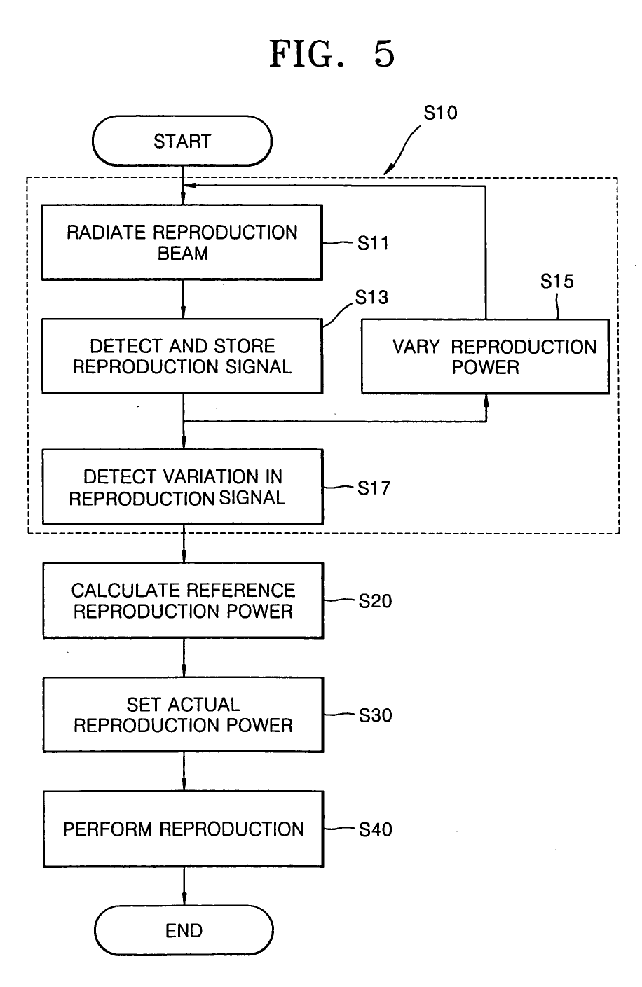

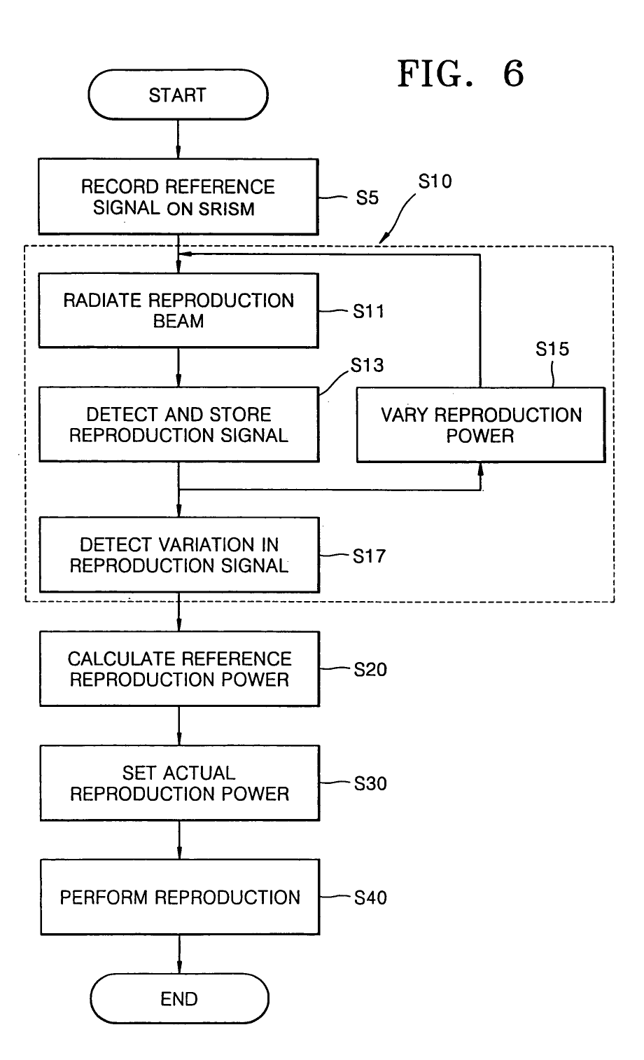

Hereinafter, an information reproducing apparatus according to an embodiment of the present invention that reproduces information using an actual reproduction power determined to be suitable for reproducing information based on a reference reproduction power, which is determined based on the gradient of a graph of reproduction signals versus reproduction power, and a method of reproducing information using the information reproducing apparatus will be described in detail with reference to FIG. 4, FIG. 5 and FIG. 6.

Referring to FIG. 4, an information reproducing apparatus according to an embodiment of the present invention includes a driving unit 10 which rotates an SRISM 1, an optical pickup unit 20 which reads a reproduction signal from the SRISM 1, and a signal processing unit 30 which processes the read reproduction signal.

The optical pickup unit 20 includes a light source 21 which radiates a light beam, a beam splitter 23 which changes the traveling path of the light beam, an objective lens 25 which focuses the light beam traveling toward the SRISM 1, and a photodetector 27 which receives the light beam reflected from the SRISM 1 and detects a reproduction signal and a reference signal from the received light beam.

Although the threshold region of the reproduction power shifts according to optical characteristics, such as reflectivity, etc., of the SRISM 1, the signal processing unit 30 actively sets an actual reproduction power of the light source 21. In other words, the signal processing unit 30 detects a change in the level of the reproduction signal according to the reproduction power of a light beam radiated onto the SRISM 1 from the light source 21 and sets the actual reproduction power of the light source 21, which is actually required for reproduction, based on the reproduction power level at which the gradient of the graph of reproduction signals versus reproduction power changes.

To this end, the signal processing unit 30 includes a power controller 31 which controls the power of the light beam emitted from the light source 21, a reproduction signal detecting portion 33 which detects the level of the reproduction signal read by the photodetector 27, and a central controller 40.

The power controller 31 adjusts the power level of the light beam emitted from the light source 21, when the SRISM 1 is initially loaded so as to obtain an actual reproduction power level according to optical characteristics of the SRISM 1. For example, during a process of determining the actual reproduction power level, the reproduction power is raised by approximately 0.1 mW from about approximately 1.0 mW to about approximately 2.0 mW. Once the actual reproduction power level has been set, the power controller 31 controls the light source 21 such that a light beam having a power level corresponding to the actual reproduction power level can be emitted from the light source 21.

The central controller 40 calculates a reference reproduction power based on a signal read by the reproduction signal detecting portion 33 and sets the actual reproduction power. To this end, the central controller 40 includes a calculating portion 41 which calculates the reference reproduction power, a setting portion 43 which sets the actual reproduction power based on the reference reproduction power, and a memory portion 45 which stores the signal read by the reproduction signal detecting portion 33. The calculating portion 41 calculates the reference reproduction power at which the gradient of the graph of reproduction signals versus a reproduction power changes. The setting portion 43 sets the actual reproduction power. The actual reproduction power set by the setting portion 43 is relatively higher than the reference reproduction power. The actual reproduction power can be about 0.1 mW greater than the reference reproduction power. Using the actual reproduction power, which lies in a range where a CNR value is stable, not in the threshold region in which the CNR value abruptly changes, signals can be stably reproduced.

A method of reproducing information from an SRISM including record marks smaller than or equal to a resolution limit of reproducing light using the information reproducing apparatus shown in FIG. 4, according to an embodiment of the present invention will be described with reference to FIG. 5.

An SRISM used in this example embodiment of the present invention includes record marks smaller than or equal to a resolution limit of an incident reproducing light, and a reference signal for calculating a reference reproduction power is recorded as data in a predetermined area, when manufacturing the SRISM 1. For example, the reference signal may be recorded as a ROM-Pit mark, a Pre-recorded mark, or a wobble on the SRISM 1.

The SRISM may be divided into a data area in which user data are recorded, a lead-in area disposed inward from the data area, and a lead-out area disposed outward from the data area. It is preferable that the reference signal is recorded in the lead-in area and/or the lead-out area.

Referring to FIGS. 4 and 5, a light beam is radiated onto the SRISM 1, while varying a reproduction power of the light beam. The light beam reflected from the SRISM 1 is received, and a change in the level of a reproduction signal is detected from the received light beam (operation S10). In particular, a reproducing light beam having a predetermined reproduction power is radiated onto an area of the rotating SRISM 1 in which a reference signal is recorded (operation S11). Here, the SRISM 1 is rotated by the driving source 10. Next, the light beam reflected from the SRISM 1 is received by the photodetector 27 to detect the reproduction signal therefrom, and the detected signal is stored in the memory 45 (operation S13). Operations S11 and S13 are repeated, while varying the reproduction power in operation S15. The levels of the reproduction signal obtained through the above-described operations are detected by the photodetector 27 (operation 17). The levels of the reproduction signal at the various reproduction power levels are plotted as shown in FIG. 3.

A reference reproduction power level at which the gradient of the graph of the reproduction signals with respect to the reproduction power levels changes (refer to B in FIG. 3) is calculated (operation S20).

Next, the power of the light source 21 is controlled so as to set an actual reproduction power that is greater than the calculated reference reproduction power (operation S30). It is preferable that the actual reproduction power is set to be about 0.1 mW greater than the reference reproduction power. By setting the actual reproduction power to this level, a stable CNR value of about 30 dB or greater can advantageously be obtained, as described above.

An information reproducing method according to another embodiment of the present invention will be described with reference to FIG. 6.

An SRISM used in this example embodiment of the present invention includes record marks smaller than or equal to a resolution limit of an incident reproducing light as in the embodiment described with reference to FIG. 5. However, no reference signal, which is used to calculate a reference reproduction power, is recorded in the SRISM used in the example embodiment of the present invention described below.

Referring to FIGS. 4 and 6, a light beam having a predetermined recording power level is radiated onto a predetermined area of the SRISM 1 to record a reference signal for calculating a reference reproduction power (operation S5). The reference signal is recorded as data by radiating a recording power of about 12 mW onto the SRISM 1 rotated at a linear velocity of about 5 m/sec by the driving source 10. It is preferable that the reference signal is recorded in a lead-in area and/or a lead-out area of the SRISM 1.

Next, a change in the level of the reproducing signal is detected (operation S10). A reference reproduction power is calculated based on the change in the level of the reproducing signal (operation S20). An actual reproduction power is set to be greater than the reference reproduction power (operation S30), so that a signal is reproduced using the actual reproduction power (operation S40).

As described from the foregoing, an apparatus and method for reproducing information from an SRISM according to the present invention advantageously and actively identify a threshold region in which a CNR signal is unstable and determine an actual reproduction power based on the threshold region, so that information reproduction can be performed at the actual reproduction power. As a result, signals can be stably reproduced from SRISMs having different characteristics, for example, from an SRISM having a particular reflectivity.

While there have been illustrated and described what are considered to be example embodiments of the present invention, it will be understood by those skilled in the art and as technology develops that various changes and modification may be made, and equivalents may be substituted for elements thereof without departing from the spirit and scope of the present invention. Many modifications may be made to adapt the teachings of the present invention to a particular situation without departing from the scope thereof. For example, other memory media may be utilized as long as record marks are not larger than a resolution limit of a light beam. In addition, alternative structures of a SRISM may also be available as long as a super resolution phenomenon can be utilized to reproduce information signals from record marks that are smaller or equal to a resolution limit of a light beam. Likewise, a central controller can be implemented as a chipset, or alternatively, a general or special purposed computer programmed to perform the methods as described with reference to FIG. 5 and FIG. 6. Accordingly, it is intended, therefore, that the present invention not be limited to the various example embodiments disclosed, but that the present invention includes all embodiments falling within the scope of the appended claims.

1. A method of reproducing information from an SRISM (super resolution information storage medium) including record marks smaller than a resolution limit of a laser beam, comprising:
radiating a laser beam onto the SRISM, while varying a reproduction power of the laser beam, receiving the laser beam reflected from the SRISM, and detecting a change in the level of a reproduction signal from the received laser beam;
calculating, based on the change in the level of the reproduction signal, a reference reproduction power at which the gradient of a graph of the levels of the reproduction signal with respect to the reproduction power changes; and
setting the actual reproduction power based on the reference reproduction power.

2. The method as claimed in claim 1, wherein a reference signal for calculating the reference reproduction power is recorded as data in a predetermined area of the SRISM, and the reproduction signal is detected by radiating the reproduction power having a range of power onto the predetermined area in which the reference signal is recorded.

3. The method as claimed in claim 2, wherein the reference signal is recorded in a lead-in area and/or a lead-out area of the SRISM.

4. The method as claimed in claim 2, wherein the reference signal is recorded as a ROM-Pit mark, a Pre-Recorded mark, or a wobble.

5. The method as claimed in claim 4, wherein the reference signal is recorded in a lead-in area and/or a lead-out area of the SRISM.

6. The method as claimed in claim 1, wherein the actual reproduction power is greater than the reference reproduction power.

7. The method as claimed in claim 6, wherein the actual reproduction power is about 0.1 mW greater than the reference reproduction power.

8. A method of reproducing information from an SRISM (super resolution information storage medium) including record marks smaller than a resolution limit of a laser beam, comprising:
recording a reference signal for calculating a reference reproduction power by radiating a laser beam having a predetermined recording power into a predetermined area of the SRISM;
radiating a laser beam onto the SRISM, while varying a reproduction power of the laser beam, receiving the laser beam reflected from the SRISM, and detecting a change in the level of a reproduction signal from the received laser beam;
calculating, based on the change in the level of the reproduction signal, a reference reproduction power at which the gradient of a graph of the levels of the reproduction signal with respect to the reproduction power changes; and
setting the actual reproduction power based on the reference reproduction power.

9. The method as claimed in claim 8 wherein the reference signal is recorded in a lead-in area and/or a lead-out area of the SRISM.

10. The method as claimed in claim 8, wherein the actual reproduction power is greater than the reference reproduction power.

11. The method as claimed in claim 10, wherein the actual reproduction power is about 0.1 mW greater than the reference reproduction power.

12. An apparatus for reproducing information from an SRISM (super resolution information storage medium) including record marks smaller than a resolution limit of a laser beam, comprising:
an optical pickup unit including a light source which radiates a light beam having a range of power onto the SRISM, and a photodetector which receives the light beam reflected from the SRISM and which detects a reproduction signal from the received light beam; and
a signal processing unit which detects a change in the level of the reproduction signal according to a change in the reproduction power of the light beam radiated onto the SRISM by the light source, and which sets the actual reproduction power of the light beam emitted from the light source based on a reference reproduction power at which the gradient of a graph of the levels of the reproduction signal with respect to the reproduction power changes.

13. The apparatus as claimed in claim 12, wherein the signal processing unit comprises:
a power controller which controls the light source such that the light beam having a range of power can be radiated onto the SRISM;
a calculating portion which calculates the reference reproduction power at which the gradient of the graph of the levels of the reproduction signal with respect to the reproduction power changes; and
a setting portion which sets the actual reproduction power of the light source based on the reference reproduction power.

14. The apparatus as claimed in claim 12, wherein the actual reproduction power is greater than the reference reproduction power.

15. The apparatus as claimed in claim 14, wherein the actual reproduction power is about 0.1 mW greater than the reference reproduction power.

16. A method comprising:
radiating a light beam, while varying a reproduction power of the light beam, onto a storage medium having record marks smaller than a resolution limit of the light beam;
receiving the light beam reflected from the storage medium, and detecting a change in the level of a reproduction signal from a received laser beam;
determining, based the change in the level of the reproduction signal, a reference reproduction power; and
adjusting the reproduction power of the light beam to an actual reproduction power, based on the reference reproduction power, so as to reproduce information recorded on the storage medium.

17. The method as claimed in claim 16, wherein the storage medium is a super resolution information storage medium (SRISM) having a data area in which user data is recorded thereon, a lead-in area disposed inward from the data area, and a lead-out area disposed outward from the data area.

18. The method as claimed in claim 17, wherein a reference signal for calculating the reference reproduction power is recorded as data in one of the lead-in area and the lead-out area of the SRISM, and the reproduction signal is detected by radiating the reproduction power having a range of power onto the area in which the reference signal is recorded.

19. The method as claimed in claim 16, wherein the reference signal is recorded as a ROM-Pit mark, a Pre-Recorded mark, or a wobble on the storage medium.

20. The method as claimed in claim 16, wherein the actual reproduction power is greater than the reference reproduction power determined, based on the change in the level the reproduction signal, at which the gradient of a graph of reproduction signals with respect to reproduction power levels changes.

21. The method as claimed in claim 16, wherein the actual reproduction power is about 0.1 mW greater than the reference reproduction power.

22. An apparatus comprising:
an optical unit including a light source which emits a light beam having a range of power onto a storage medium having record marks smaller than a resolution of the light beam, and a photo-detector which receives the light beam reflected from the storage medium and detects a reproduction signal from a received light beam; and
a signal processing unit which detects a change in the level of the reproduction signal according to a change in the reproduction power of the light beam radiated onto the storage medium by the light source, and which sets the actual reproduction power of the light beam emitted from the light source based on a reference reproduction power, so as to reproduce information from the storage medium.

23. The apparatus as claimed in claim 22, wherein the reference reproduction power is determined, based on the change in the level of the reproduction signal, at which the gradient of a graph of the levels of the reproduction signal with respect to the reproduction power changes.

24. The apparatus as claimed in claim 22, wherein the signal processing unit comprises:
a power controller which controls the light source such that the light beam having a range of power can be radiated onto the storage medium;
a calculating portion which calculates the reference reproduction power at which the gradient of the graph of the levels of the reproduction signal with respect to the reproduction power changes; and
a setting portion which sets the actual reproduction power of the light beam based on the reference reproduction power.

25. The apparatus as claimed in claim 22, wherein the actual reproduction power is greater than the reference reproduction power.

26. The apparatus as claimed in claim 22, wherein the actual reproduction power is about 0.1 mW greater than the reference reproduction power.

27. The apparatus as claimed in claim 22, wherein the storage medium is a super resolution information storage medium (SRISM) having a data area in which user data is recorded thereon, a lead-in area disposed inward from the data area, and a lead-out area disposed outward from the data area.

28. The apparatus as claimed in claim 27, wherein a reference signal for calculating the reference reproduction power is recorded as data in one of the lead-in area and the lead-out area of the SRISM, and the reproduction signal is detected by radiating the reproduction power having a range of power onto the area in which the reference signal is recorded.

29. The apparatus as claimed in claim 28, wherein the reference signal is recorded as a ROM-Pit mark, a Pre-Recorded mark, or a wobble on the storage medium.
